(19) United States
(12) Patent Application Publication
(10) Pub. No.: US 2003/0217488 A1
(43) Pub. Date: Nov. 27, 2003

(54) Postcard with data carrier

(76) Inventors: Jehoshua Chmiel, Munchen (DE); Roland Fein, Munchen (DE); Christian Hafner, Munchen (DE)

Correspondence Address: KALOW & SPRINGUT LLP, 488 MADISON AVENUE, 19TH FLOOR, NEW YORK, NY, 10022, US

(21) Appl. No.: 10/438,714

(22) Filed: May 15, 2003

(30) Foreign Application Priority Data
May 15, 2002 (DE) 202 07 680.6
May 15, 2002 (DE) 202 07 681.4

(51) Int. Cl. G09F 1/00

(52) U.S. Cl. 40/124.19

(57) ABSTRACT

The invention related to a postcard or information carrier, comprising one or more peripheral sides capable of being folded onto a first side and joined, forming a receiving space for a data carrier, wherein the one or more peripheral sides cannot be opened unintentionally and the data carrier cannot be lost. The invention also provides a method of generating a customer database, comprising mailing or delivering a postcard to an addressee, wherein the postcard includes a reply postcard that requires information to be furnished by the addressee, and having a data carrier that includes information of interest to the addressee, receiving the reply postcard from the addressee, converting the information into computer-readable format to generate a customer database based on the information furnished by the addressee, and using the customer database to generate a mailing list to solicit or send further information or products to the addressee.

### BACKGROUND OF INVENTION

The state of the art, such as, e.g., DE 200 21 924 U1, discloses postcards which can be equipped with a CD. This postcard consisting of cardboard comprises an indentation on the back into which the CD is placed. Around the indentation, an adhesive portion is provided onto which a film is glued which covers the CD and prevents it from falling out. The postcard, however, has the disadvantage that the indentation on the front of the postcard, on which usually a motif is printed, considerably impairs the postcard from an optical point of view. Furthermore, the cardboard of the postcard must exhibit an extra space on the back for receiving the writing since films generally are only adapted to be written on with specific pens. Moreover, films—and thus the inserted CD—can easily be damaged by sharp objects during transport.

A further packaging member for a disc is known from DE 295 13 533 U1. The packing member for a disc consists of a sheet area which is divided into four successive portions by three folding lines arranged in parallel. An outer folding line exhibits in its longitudinal direction a slot into which the disk is inserted. The portions are then folded around the disk, and a tab which is realized on one of the outer portions is inserted into a slot of a portion so that the portions are kept in their wound condition. This packaging member has the disadvantage that it is open on its side so that not only dirt but also other objects which may damage the disk can easily penetrate. Furthermore, a relatively large sheet area is necessary for forming the four portions to be wrapped around the disk.

DE 200 21 924 U1 discloses a postcard which comprises an impression for receiving a CD, said impression being closed with a film after the insertion of the CD.

Furthermore, DE 299 01 081 U1 discloses a greeting card consisting of a cover sheet and a holding sheet, wherein the holding sheet is two-walled. One wall of the holding sheet comprises retaining clips for inserting and fixing a CD. Once the CD has been inserted, the wall is folded down inwardly onto the other wall of the holding sheet and the cover sheet is folded down over it. A flap of the cover sheet is inserted into a slot on the outside of the holding sheet to keep the greeting card closed.

From the state of the art, only postcards or information carriers are known which may be provided with a data carrier but do not comprise any elements permitting to be separately used as a postcard.

### SUMMARY OF THE INVENTION

The invention relates to a postcard or an information carrier which can be provided with a data carrier and comprises at least one portion which, independently thereof, can again be dispatched as postcard.

The phrase “information carrier” includes any printed matter that is designed to convey information. Information carriers include, but are not limited to, printed matter such as, for example, postcards, tickets, menus and advertisements. Information carriers include printed matter, which may include but is not limited to text, in conjunction with a data carrier.

It is an object of the invention to provide a postcard or an information carrier which in addition to dispatching a data carrier permits that part of the postcard can be reused, and thus the postcard gets an additional possibility of use as well as a considerable increase in value.

This object is achieved according to the invention with the features of the claims. The postcard or information carrier of the invention has the advantage that, on the one hand, a data carrier such as a music CD can be dispatched and, on the other hand, parts of the postcard or information carrier packaging can be independently reused as a postcard. This provides the postcard or information carrier according to the invention with a considerable additional value and the packaging is optimally used.

It is therefore an object of the invention to create a postcard or an information carrier which can be provided with a data carrier, such as, e.g., a CD or a disk, wherein the postcard or information carrier can be produced easily and at reasonable cost, and the data carrier is sufficiently protected against damage and falling out without impairment of the appearance of the postcard or information carrier.

This object is achieved according to the invention by means of the features of the claims. It has thus been achieved that, only by folding and joining, a postcard or an information carrier can be provided with a data carrier and dispatched with it, without said postcard or information carrier unintentionally opening, for instance, during its transport. Furthermore, portions at the peripheral sides of the postcard or information carrier prevent the data carrier from laterally slipping out. Besides, the postcard or information carrier does not require an extensive blank since the portions do not have to be wrapped around the postcard or information carrier as in the state of the art. The folding and joining of the portions of the postcard or information carrier also provide the possibility of continuing to use the postcard or information carrier simply as an original, space-saving enclosure for the data carrier in which it is protected against dirt and damage since the postcard can easily be repeatedly opened and closed. In contrast, if a film which has been glued on is used, as described above in connection with the state of the art, said film must be torn open. A further advantage of the postcard or information carrier according to the invention is that it can easily be unfolded so that the entire area of the postcard or information carrier and its portions is visible and, for instance, can be completely or partially used to be written on or can also be printed with an advertisement.

The subject matter of the subclaims represent further preferred embodiments.

The present invention provides a postcard, comprising one or more peripheral sides capable of being folded onto a first side and joined, forming a receiving space for a data carrier, wherein the data carrier being a predetermined size that fits within said receiving space and wherein the one or more peripheral sides are sealed so that the one or more peripheral sides cannot be opened unintentionally and the data carrier cannot be lost.

The invention also provides an information carrier, comprising one or more peripheral sides capable of being folded onto a first side and joined, forming a receiving space for a data carrier, wherein the data carrier being a predetermined size that fits within said receiving space and wherein the one or more peripheral sides are sealed so that the one or more peripheral sides cannot be opened unintentionally and the data carrier cannot be lost.

The invention also provides a method of generating a customer database, comprising: mailing or delivering the postcard of claim 1 to an addressee, wherein said postcard includes a reply postcard that requires information to be furnished by the addressee, and wherein said data carrier includes information of interest to the addressee; receiving said reply postcard, and converting said information into computer-readable format to generate a customer database based on the information furnished by the addressee; and using said customer database to generate a mailing list to solicit or send further information or products to the addressee.

For a better understanding of the present invention together with other and further advantages and embodiments, reference is made to the following description taken in conjunction with the examples, the scope of the which is set forth in the appended claims.

### BRIEF DESCRIPTION OF THE FIGURES

The preferred embodiments of the invention have been chosen for purposes of illustration and description but are not intended to restrict the scope of the invention in any way. The preferred embodiments of certain aspects of the invention are shown in the accompanying figure, wherein:

FIG. 1(a) shows the rear view of one embodiment of the invention in which the postcard is unfolded,

FIG. 1(b) shows the folded postcard according to an embodiment of the invention.

FIG. 2(a) shows a rear view of an embodiment of the invention in which the postcard is unfolded.

FIG. 2(b) shows the folded postcard according to an embodiment of the invention.

FIG. 3(a) shows the rear view of another embodiment of the invention in which the postcard is unfolded.

FIG. 3(b) shows the folded postcard according to an embodiment of the invention.

FIG. 4(a) shows the rear view of an embodiment of the invention in which the postcard is unfolded.

FIG. 4(b) shows the folded postcard according an embodiment of the invention.

FIG. 5(a) shows the rear view of an embodiment of the invention in which the postcard is unfolded.

FIG. 5(b) shows the folded postcard according to an embodiment of the invention.

FIG. 6(a) shows the rear view of an embodiment of the invention in which the postcard is unfolded.

FIG. 6(b) shows the folded postcard according to an embodiment of the invention.

FIG. 7(a) shows the rear view of an embodiment of the invention in which the postcard is unfolded.

FIG. 7(b) shows the folded postcard according to an embodiment according to the invention.

FIG. 8(a) shows the rear view of an embodiment of the invention in which the postcard is unfolded.

FIG. 8(b) shows the folded postcard according to an embodiment of the invention.

FIG. 8(c) shows a sectional view through a portion of the postcard which is provided with an indentation and a raised portion for receiving and fixing a data carrier.

FIG. 9(a) shows a rear view of an embodiment of the invention in which the postcard is unfolded.

FIG. 9(b) shows a rear view of the postcard according to an embodiment of the invention provided with a data carrier for dispatch.

FIG. 9(c) shows a front view of the postcard according to FIGS. 9(a), (b).

FIG. 10(a) shows a rear view of an embodiment of the invention in which the postcard is unfolded.

FIG. 10(b) shows a rear view of the postcard according to an embodiment of the invention provided with a data carrier for dispatch.

FIG. 10(c) shows a front view of the postcard according to FIGS. 10(a), (b).

FIG. 11(a) shows a rear view of an embodiment of the invention in which the postcard is unfolded.

FIG. 11(b) shows a rear view of the postcard according to an embodiment of the invention provided with a data carrier for dispatch.

FIG. 11(c) shows the postcard after the data carrier has been removed, wherein the portion (52) has been torn open along the perforations (56).

FIG. 12(a) shows a rear view of an embodiment of the invention in which the postcard is unfolded.

FIG. 12(b) shows a rear view of the postcard according to an embodiment of the invention provided with a data carrier for dispatch.

FIG. 12(c) shows the postcard after the data carrier has been removed, wherein the portion (52) has been torn open along the perforations (56).

FIG. 13(a) shows a rear view of an embodiment of the invention in which the postcard is unfolded.

FIG. 13(b) shows a rear view of the postcard according to an embodiment of the invention provided with a data carrier for dispatch.

FIG. 13(c) shows the postcard after the data carrier has been removed. FIG. 14(a) shows a rear view of the postcard according to an embodiment of the invention provided with the data carrier.

FIG. 14(b) shows the folding of the portions as well as the arrangement of a data carrier between the portions.

FIG. 15(a) shows a rear view of the postcard according to an embodiment of the invention provided with the data carrier.

FIG. 15(b) shows a rear view of the postcard according to an embodiment of the invention provided with a data carrier for dispatch.

FIG. 15(c) shows the postcard after the data carrier has been removed.

FIG. 16(a) shows a rear view of the postcard according to an embodiment of the invention provided with the data carrier.

FIG. 16(b) shows a rear view of the postcard according to an embodiment of the invention provided with a data carrier for dispatch.

FIG. 16(c) shows the postcard after the data carrier has been removed.

### DETAILED DESCRIPTION OF THE PREFERRED EMBODIMENTS

The present invention will now be described in connection with preferred embodiments. These embodiments are presented to aid in an understanding of the present invention and are not intended to, and should not be construed, to limit the invention in any way. All alternatives, modifications and equivalents that may become obvious to those of ordinary skill upon reading the disclosure are included within the sprit and scope of the present invention.

This disclosure is not a primer on postcards, information carriers or data carriers; basic concepts known to those skilled in the art have not been set forth in detail.

The phrase “information carrier” includes any printed matter that is designed to convey information. Information carriers include, but are not limited to, printed matter such as, for example, postcards, tickets, menus and advertisements. Information carriers include printed matter, which may include but is not limited to text, in conjunction with a data carrier.

The present invention provides a postcard, comprising one or more peripheral sides capable of being folded onto a first side and joined, forming a receiving space for a data carrier, wherein the data carrier being a predetermined size that fits within said receiving space and wherein the one or more peripheral sides are sealed so that the one or more peripheral sides cannot be opened unintentionally and the data carrier cannot be lost.

The postcard can comprise a slot in at least one of the one or more peripheral sides wherein said slot is capable of receiving a portion of a second peripheral side. The postcard can further comprise a tab on at least one of the one or more peripheral sides, wherein said tab can be received by said slot. The postcard can further comprise an adhesive portion on at least one of the one or more peripheral sides. The adhesive portion can be comprised of any suitable substance or form sufficient to hold the data carrier in place. The postcard can also comprise adhesive label adhered to said at least one or more peripheral sides. At least one of the one or more peripheral sides can be made separable by introducing one or more perforations, preferably along the fold line.

The data carrier can be selected from the group consisting of a credit card, a computer disk, a compact disk, a CD-ROM, a DVD, a mini CD, a trimmed CD, a CD of a thin film material, and a video disk. The data carrier can be made accessible by removing fully or partially at least one of the peripheral sides. The data carrier can be fixed to the postcard by a recess, a raised element, or an adhesive spot.

The postcard can further comprise a means for fixing the data carrier to the postcard. The means for fixing the data carrier to the postcard can include, for example, an indentation, a raised area, an adhesive material, a clip, a tab, a slot, or any combination of these means.

The postcard preferably comprises an Advent calendar, a greeting card, or a permission ticket.

At least one of the one or more peripheral sides is preferably capable of being reused as a reply postcard. Preferably, the postcard comprises at least two peripheral sides, wherein at least one of the two peripheral sides is adapted to be written on. In one embodiment, the postcard can comprise at least two peripheral sides, wherein said at least two peripheral sides include a separable adhesive joint.

In another embodiment, the postcard comprises at least two peripheral sides that are foldably connected to the first side, and wherein the receiving space for the data carrier is formed by the two peripheral sides folded onto the first side, and wherein at least one of two peripheral sides is separable, and wherein the first side comprises a postcard.

The postcard can comprise at least one peripheral side that is attached to the first side by an adhesive joint. The at least one peripheral side can comprise doors capable of being opened by perforation means.

The invention also provides a method of generating a customer database, comprising: mailing the postcard of claim 1 to an addressee, wherein said postcard includes a reply postcard that requires information to be furnished by the addressee, and wherein said data carrier includes information of interest to the addressee; receiving said reply postcard, and converting said information into computer-readable format to generate a customer database based on the information furnished by the addressee; and using said customer database to generate a mailing list to solicit or send further information or products to the addressee.

The method of generating a customer database may include a postcard that comprises an admission ticket, a contest entry, or a calendar. Any information of interest can be included in the postcard. Preferably, the information of interest included in the postcard includes information that is valued by the addressee. Information valued by the addressee includes, for example, admission to an arts or sporting event in the form of an admission ticket; a chance to win a prize in the form of a contest entry; a calendar such as, for example, an Advent calendar; images or motifs that pique the interest of the addressee, such as images of matters desirable to consumers such as sports cars, money, and leisure activities such as holiday and travel. The information preferably raises the addressee's interest in the postcard and represents value to the addressee. The information can be included in the data carrier and/or the postcard. Preferably, the information is printed in photographs, text, or motifs on the postcard itself.

The information can direct the addressee to products and/or services and/or a homepage in the internet offered by the sender, or may be unrelated to the sender's business. For example, a charitable organization can use the postcard to solicit donations, and the information included in the data carrier and/or the postcard can be directed to the consumer's interest in cars, high fashion, sports, arts, entertainment, leisure activities, travel, etc. In this way, the charitable organization sending the postcard can capitalize on the consumer's interest in goods and entertainment while the charitable organization's partner(s) can capitalize on the beneficial connection between consumption of its products and support for charitable causes.

Preferably, the postcard includes information and/or motifs that make the addressee recognize the necessity to act in response to receiving the postcard by, for example, filling out and mailing a reply postcard, entering a contest, or the like.

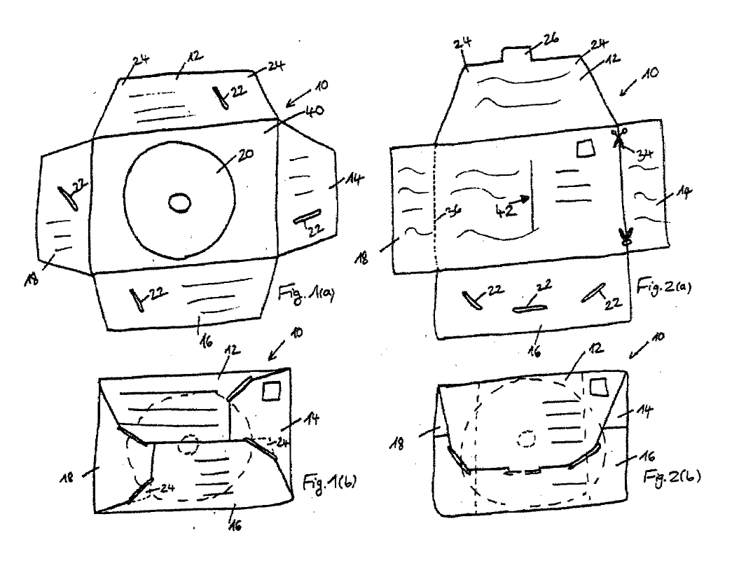

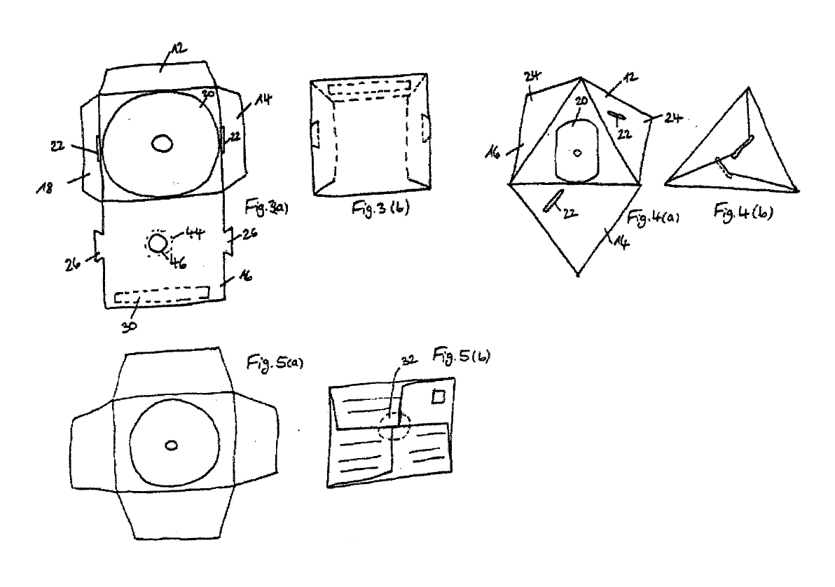

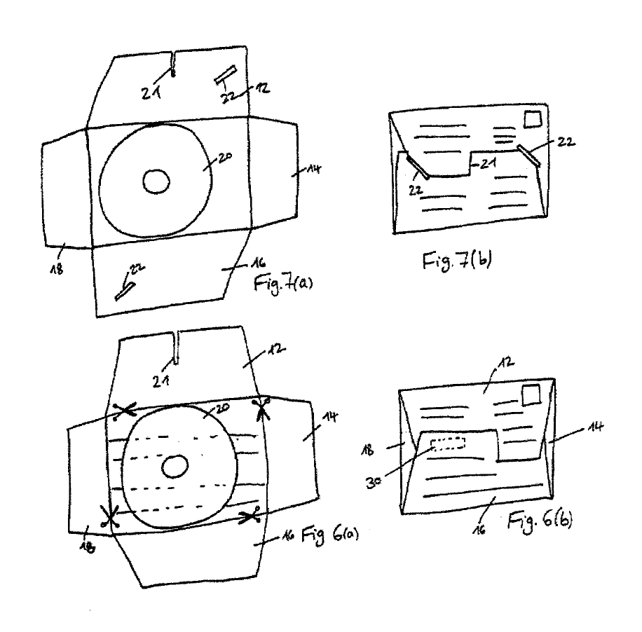

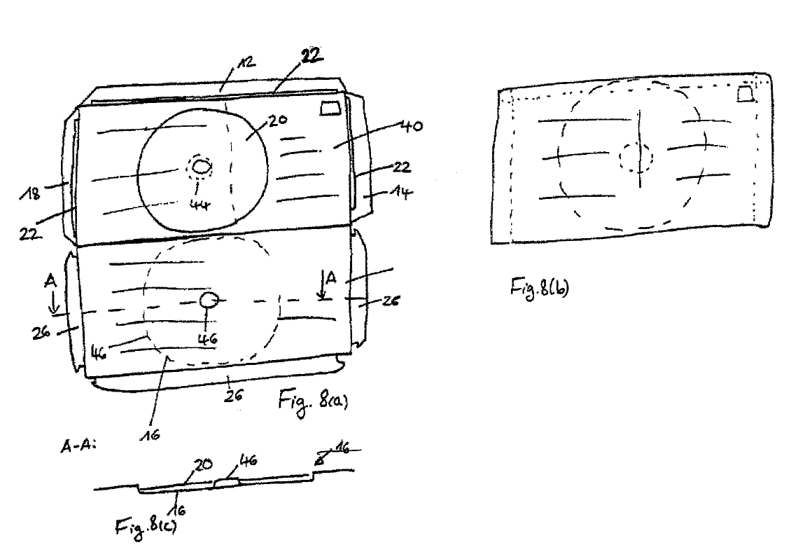

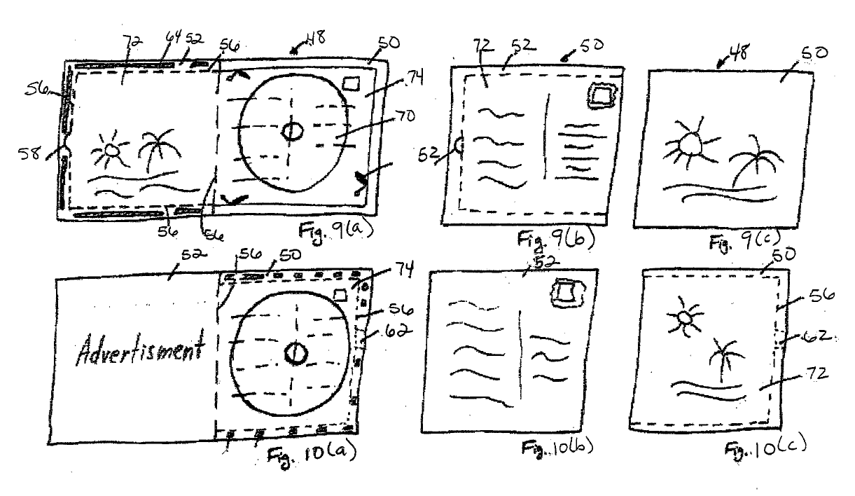

Certain preferred embodiments of the postcard will now be explained. In FIG. 1(a), preferably each of the portions 12, 14, 16, 18 is provided with a slot 22 at the peripheral side of the postcard 10. A data carrier 20, such as a CD or a disk, is arranged on the back of the postcard and the portions are folded down onto each other, as shown in FIG. 1(b), wherein one partial portion 24 of every portion is inserted into the slot 22 of the successive portion. By means of inserting the partial portions 24 into the respective slots 22 and on account of the fact that the portions 12, 14, 16, 18 are folded down onto each other such that they mutually partially overlap one of their ends as shown in FIG. 1(b), it is achieved in a very simple way that the postcard can be kept in its folded condition without the data carrier falling out. In particular, it is also conceivable that, for instance, the postcard can also be used later for safekeeping the data carrier since, on the one hand, it protects the data carrier and, on the other hand, the connection provided by folding and inserting the respective portions into the respective slots can always be easily opened and closed again, in contrast to the above described film which has been glued on and must be torn open.

FIGS. 2(a) and 2(b) illustrate a postcard in which only one portion comprises slots 22, wherein a respective portion 12 can comprise an additional partial portion 26 in the form of a tab. The portions 14, 18 serve to prevent the data carrier 20 from laterally slipping out, while the portions 12, 16 upon folding down are joined by inserting the partial portions 24, 26 into the respective slots 22 such that the postcard is kept in a closed form.

This embodiment has the advantage that only two portions 12, 16 have to be joined while the other two portions 14, 18 are only folded down inwardly onto the postcard.

In FIGS. 3(a), (b), a postcard is shown in which at least two portions 14, 18 comprise slots 22, into which partial portions 26 of a portion 16 are inserted, while a portion 12 must only be folded down. Additionally an adhesive joint 30 can preferably be provided on the portion 12 or 16 as an additional safeguard for keeping the postcard closed, wherein the two portions 12, 16 are thereby connected with each other upon folding. This embodiment is also a very simple and reasonable possibility for a postcard according to the invention.

FIGS. 4(a), (b) show an example of a postcard having only three peripheral sides. In this embodiment, firstly the portion 14 is folded down onto the back of the postcard and then the portion 12. A partial portion 24 of said portion 12 is inserted into the slot 22 of said portion 14, and finally the portion 16 is folded down as shown in FIG. 4(b) and the respective partial portion 24 of said portion 16 is inserted into the slot 22 of portion 12. It is also conceivable to provide only one of the portions with a slot and another with a corresponding partial portion in the form of a tab in order to fold down and joint the portions such that the postcard can be kept in a closed form (not shown).

In FIGS. 5(a), (b), an embodiment similar to the one described in FIGS. 1(a), (b) is described, wherein no slots 22 are used. In this embodiment, each of the portions 12, 14, 16, 18 is folded down and respectively inserted in such a way that is overlaps a partial portion of the successive portion. This embodiment represents a postcard for receiving a data carrier which postcard is particularly simple to produce and in which no additional slots are used for keeping the postcard in a folded condition.

FIGS. 6(a), (b) show an embodiment of the invention in which two opposite lateral portions 14, 18 are only folded down onto the back of the postcard to prevent the data carrier from falling out. The portions 12, 16 are used to keep the postcard closed in that they are folded down and are joined via a slot 21 in the portion 12. As an additional safeguard for preventing the postcard from unintentionally opening, portions may be connected with each other via an adhesive joint 30.

In a further embodiment of the invention as shown in FIGS. 7(a), (b), the portions 12, 16 comprise additional slots 22, into which partial portions of the portions 12, 16 can be inserted to thus additionally ensure that the portions are held together and prevent the postcard from unintentionally opening.

In FIGS. 8(a), (b), the postcard comprises a portion 16 with partial portions 26 at the periphery, which are inserted into the slots 22 of the portions 12, 14, 18 to keep the postcard in its folded condition and prevent the data carrier from falling out and being damaged.

In a preferred embodiment, the postcards shown in the drawings comprise an Advent calendar as motif. Said Advent calendar is preferably made of two-walled cardboard with doors on a front wall, wherein said doors comprise perforations and can be opened along said perforations. Motifs to be seen when opening the doors can be printed on the rear wall. The two-walled cardboard comprising the postcard can comprise portions 12, 14, 16, 18 at its front and rear walls which can be folded and joined to be able to safely receive a data carrier according to the above-described embodiments.

In a further preferred embodiment, it is conceivable to realize one of the portions 12, 14, 16, 18 to be separated as admission ticket, for instance by providing it with a bar code or the like.

Each of the described embodiments can further comprise separable portions 12, 14, 16, 18, as exemplarily shown in FIG. 2(a). Said portions can be realized to be separable by perforations or any other known techniques. Each of the portions 12, 14, 16, 18 can be provided, for instance, with a symbol for scissors, which is particularly simple and reasonable in terms of production and indicates that said portions can be cut off to be able to use the postcard a second time. In this embodiment, the inner field 40 can be written on, addressed and stamped, as exemplarily shown in FIG. 8(a). Furthermore, it is possible to realize the perforations and the associated portions (12, 14, 16, 18) such that they can be separated from the postcard along any desired contour, i.e. not as shown in the drawings only along the sides of the postcard yielding a rectangular contour.

In a particularly preferred embodiment, an address field or blank 42 may be printed on the postcard in the inner field 40, as illustrated in FIG. 2(a). The portions 12, 14, 16, 18 as well as the inner field 40 can additionally be used as advertising area for advertising slogans in the inside or can additionally be a writing area. It is also readily possible to add further inserts to the postcard provided with the data carrier, such as information or advertising leaflets. Preferably, portions 12, 14, 16, 18 are realized such that they overlap the data carrier at least partially. It is particularly preferred that portions overlap the data carrier in their folded and joined condition so that in this condition said data carrier is completely covered by at least one portion (see, e.g., FIGS. 3(a), (b) and 8(a), (b)) and/or by a combination of several portions (see, e.g., FIGS. 1(a), (b)).

A portion 16 which is large in comparison to the other portions 12, 14, 18, as shown in FIG. 3(a) or FIG. 8(a), has the advantage that the writing area is essentially restricted to one portion and thus gets particularly clear, whereas the portions, e.g., in FIG. 1(a) or FIG. 2(a) can be used evenly for any writing on the postcard. On the one hand, this is applicable in case of writing on the back of the postcard in its folded and joined condition, as shown, e.g., in FIGS. 1(b) to 8(b) and in case of additionally writing on the inside of the postcard, as shown, e.g., in FIG. 1(a) and FIG. 8(a).

On the inner field 40 or one of the portions, the postcard preferably comprises an adhesive spot 44 or a stick-on rest 46 for a data carrier (roughly indicated in FIGS. 3(a), 8(a), (c)). In addition to the possibilities described above for fixing a data carrier, a raised part and/or an indentation (also referred to with reference sign 46) is also conceivable for receiving and fixing the data carrier 20, wherein in this case a raised part or an indentation does not impair the motif on the front of the postcard from an optical point of view, as described above in connection with the state of the art.

Furthermore, portions preferably overlap the data carrier in their folded condition, as shown, e.g., in FIG. 1(b), FIG. 2(b), FIG. 3(b), so that it is additionally protected against slipping out during the transport of the postcard.

Preferably, the portions 12, 14, 16, 18 and their partial portions 24, 26 can be realized to get additionally interlocked upon insertion, as exemplarily shown, e.g., in FIG. 8(a), which additionally helps to avoid that the postcard gets unintentionally open.

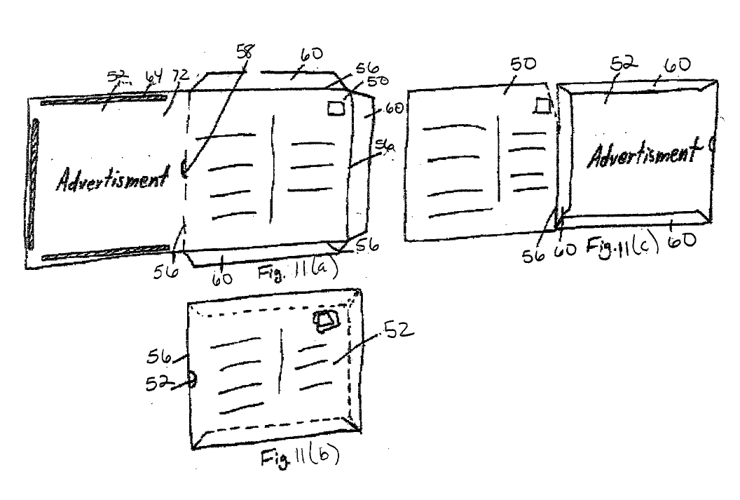

In FIG. 9(a), a postcard is shown which comprises two portions 50, 52. A motif is printed on the front of a first portion 50 and the back of said first portion 50 is adapted to be written on. The second portion 52 has at least one side that is adapted to be written on. The other side, which is folded down inwardly onto the back of the postcard, can be adapted to be written on or a motif can be printed on it, such as a postcard motif or an advertisement (as exemplarily shown, e.g., in FIG. 9(a) and FIG. 11(a), respectively). The two portions 50, 52 are folded down onto each other, wherein the motif of the first portion 50 and one side of the second portion 52 which is adapted to be written on face outwardly. A data carrier 70 is arranged between the two portions and the portions are preferably connected with each other by means of an adhesive joint 64 so that the data carrier cannot be removed unintentionally and is sufficiently protected against damage.

For the purpose of removing the data carrier 70 from the postcard 48, at least one of the portions 50, 52 is preferably provided with perforations 56 which form an appropriate partial portion 72 through which the data carrier 70 can be removed. For this purpose, the portion 52 forming the back of the postcard 48 exhibits perforations 56 as well as preferably a recess 58 to additionally facilitate the separation of the partial portion 72. The portion 50, which may exhibit the postcard motif on its front, may be separated from the remaining adhesive portions 64 at the periphery, for instance, by perforations or by cutting off said portions 64 to provide the partial portion 74 (cutting lines marked with a scissors symbol).

Thus, the portion 50 may be reused as a postcard with the same postcard motif. Furthermore, if, for instance, the postcard motif or any other motif is printed on the inside, the recipient of the postcard can keep the originally received message with a motif on the other side as a “postcard”, as suggested, e.g., in FIG. 9(a).

FIG. 10(a) depicts a postcard in which the portion 50 exhibiting the postcard motif on its front (see FIG. 10(c)) is provided with perforations 56. Furthermore, for the purpose of facilitating the removal of a partial portion 44 formed by the perforations 56, a tab 62 is provided for tearing open and separating said partial portion 74. The tab 62 is preferably realized such that it can be torn or cut off after the partial portion has been separated. The partial portion 74 can then independently be reused as a postcard. The inside of the second portion 52 can be provided with an advertising slogan as in FIG. 10(a) or with a postcard motif (not shown). Said portion 52 can preferably be realized such that it can also be separated from the adhesive portions 64 or cut off to provide a partial portion (like the portion 50 in FIG. 9(a)).

This embodiment has the advantage that the partial portion 74 can be used, on the one hand, for removing the data carrier 70 and, on the other hand, independently as a postcard.

In FIG. 11(a), a postcard 48 is shown in which a portion 50, 52 comprises partial portions 60. As shown in FIGS. 1(a), (b), (c), the so-called motif portion 50, i.e., the portion exhibiting a motif that forms the front of the postcard 48, comprises partial portions 60 at its peripheral sides. Said partial portions 60 are preferably realized to be separable from said portion 50 by perforations 56 and/or folds. Furthermore, said partial portions 60 are connected with the second portion 52, for instance, by an adhesive joint.

For the purpose of removing a data carrier 70, preferably a recess 58 or a tab 62 can be provided on one of the portions 50, 52, said recess 58 or tab 62 permitting that the respective portion can be separated more easily. As shown in FIG. 11(c), the portion 52 is separated such that the partial portions 60 are separated together with it from the motif portion 12. This has the advantage that the motif portion can be independently used as a postcard while maintaining its original size. Furthermore, the partial portions 60 and the adhesive portions 64 can be cut off the portion 52 or removed in any other way so that a postcard, e.g., with an advertising slogan and the original message is maintained (see FIG. 11(c)).

This embodiment has the advantage that a postcard for independent dispatch can be obtained which maintains its original size.

FIGS. 12(a), (b), (c) depict a further embodiment of the postcard according to the invention. In this embodiment, both portions 50, 52 comprise partial portions 60 which can be connected with each other preferably by gluing. For the purpose of removing a data carrier 70, preferably a recess 58 or a tab 62 can be provided on one of the portions 50, 52, said recess 58 or tab 62 permitting that the respective portion 50, 52 can be separated more easily. For this purpose, the partial portions 60 are preferably realized to be separable from the portions 50, 52 by perforations or folds.

Furthermore, as shown in FIG. 12(c), once the portions 50, 52 have been torn open or separated, the partial portions 60 can be torn or cut off as here from portion 50. This embodiment has the advantage that both the portion 50 to be used independently as a postcard and the portion 52 with the original message maintain their original sizes.

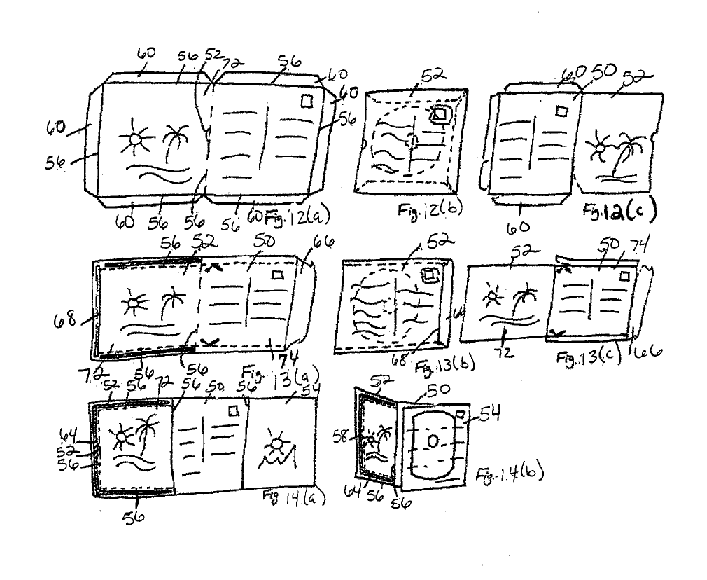

FIGS. 13(a), (b), (c) show a postcard in which one portion, preferably the motif portion 50, comprises an insert tab 66. The portion 52 accordingly comprises a slot 66 into which the insert tab 66 is inserted once the two portions 50, 52 have been connected by an adhesive joint 64 and a data carrier 70 has been arranged between the portions 50, 52. For removing the data carrier, the insert tab 66 is simply taken out of the slot 68. Furthermore, at least one of the portions can be separated from the adhesive joint preferably by perforations 56 and/or folds and/or by cutting it off with scissors to provide the partial portion 72, 74. As shown in FIG. 13(a), the portion 52 exhibits perforations by means of which it can be separated, wherein the portion 50, e.g., exhibits scissors symbols which indicate that the portion 50 can be separated there from the adhesive joint and used as a separate postcard. Instead of perforations or a scissors symbol, it is also possible to provide folds or the like as well as a combination thereof for separating portions 50, 52 as well as partial portions 72, 60.

FIGS. 14(a), (b) show a postcard consisting of three successive portions 50, 52, 54. The middle portion 50 forms the front of the postcard 48 with the motif, while an outer portion 52 forms the back of the postcard which is adapted to be written on. A further outer portion 54 can additionally be realized as an independent postcard in that the one side of said portion 54 is adapted to be written on while the other side of it exhibits a motif. The two outer portions are folded down onto the postcard and a data carrier 70 is provided therebetween, as illustrated in FIG. 14(b). Furthermore, the outer portion 52 exhibits perforations 56 by means of which a respective partial portion 72 can be separated and the data carrier removed. The portions 50 and 54 can be independently used as postcards, wherein the portion 50 maintains its original size since no adhesive portions have to be removed or separated or cut off such as in case of the portion 54.

This embodiment has the advantage that two portions can be independently used as postcards.

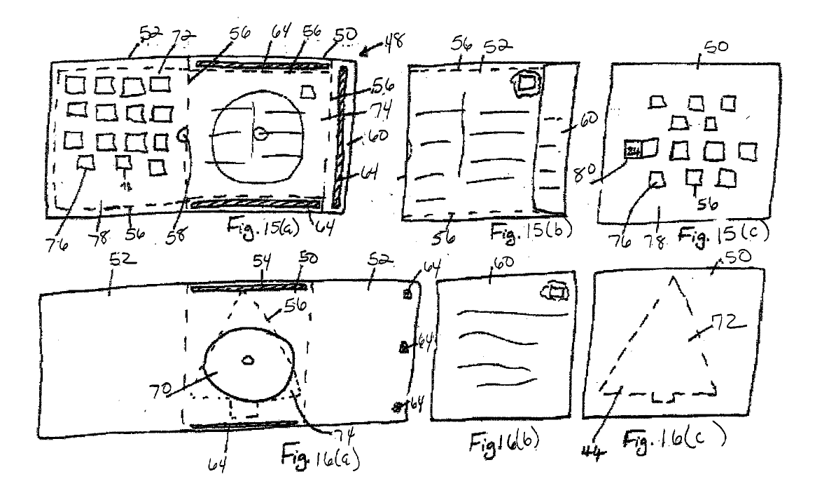

FIGS. 15(a), (b), (c) illustrate another embodiment of the invention. In this embodiment, the postcard 48 comprises two portions 50, 52 and a partial portion 60 at one of the portions, preferably at the portion 50 forming the front of the postcard 48 with the motif.

The postcard 48 may have an Advent calendar 78 as the motif. Said Advent calendar 78 is preferably made of a two-walled cardboard or paper. A front wall is provided which comprises doors 60 to be opened and a back wall is provided onto which motifs can be printed that are exposed when the respective doors 76 are opened.

The portions 50, 52 are connected with each other at the right and left sides via adhesive portions 64, wherein a data carrier 70 is provided between the portions. The partial portion 60 is then folded down onto portion 52 and preferably connected with it by means of an adhesive joint 64. Moreover, the portion 52 forming the back of the postcard 48 preferably can also comprise an Advent calendar 78 as described above (see FIG. 15(a)) or, e.g., another Christmas motif on the side that is folded down inwardly onto the postcard. The portion 50, which comprises an Advent calendar on the front of the postcard 48, as shown in FIG. 15(c), is preferably provided with perforations 56 by means of which the portion can separated and dispatched as a separate postcard. It is particularly preferred that for this purpose a recess facilitating the separation is provided at the portion 52. The portion 52 can also be realized to be separable from the portion 50 by the provision of perforations 56 so that as shown in the embodiment with two Advent calendars (see FIGS. 15(a), (c)), the recipient keeps one Advent calendar and can dispatch the other.

In another embodiment of the invention, as illustrated in FIGS. 16(a), (b), (c), the postcard comprises three portions 50, 52 and an extended partial portion 60 at one side. The portion 50 forms the front of the postcard 48 with the motif and is realized to be separable by means of perforations 56, wherein the perforations preferably can have any outline whatsoever, such as, for instance, a Christmas tree (see FIGS. 16(a), (c)). The portions 50 and 52 are connected with each other at the right and left sides via adhesive portions 26, wherein a data carrier 70 is provided between the portions. The partial portion 60 is folded down onto the portion 14 and connected with it via an adhesive joint 64. In this embodiment, the partial portion 60 has preferably the same size as the portions 50, 52 (see FIG. 16(b)).

The invention is not restricted to the shown embodiments but it also comprises combinations of the embodiments and individual elements thereof.

Furthermore, the side of a postcard that can be used independently of the postcard 48 preferably comprises a blank writing field on the side adapted to be written on. Furthermore, recesses 58 or tabs 62, as described above, can be provided for facilitating the separation along perforations or folds, wherein the perforations and folds can have any outline whatsoever which can be separated.

Any media for storing data can be used as data carriers, in particular disks, CDs, CD-ROMS, new types of CDs of a thin, flexible material, trimmed CDs, mini CDs, DVDs, memory chips, SupremeCARD as well as, e.g., adhesive films such as, for example, scotch tapes on which also data can be stored.

Having now generally described the invention, the same may be more readily understood through the following reference to the following examples, which are provided by way of illustration and are not intended to limit the present invention unless specified.

### EXAMPLES

The following examples are intended to explain the invention further.

### Example I

### The Postcard and Greeting Card Collection With Integrated CD/DVD in Connection With a Flyer Campaign

A company, such as, for example, a charitable organization, can launch a flyer campaign to arouse great interest among the group of flyer recipients. For taking up contact, the company can organize a call center where, according to the present concept, the subject matter of the present invention (hereinafter also referred to as “echocard”) may be ordered in packs with different motifs. It is sent out by the respective buyers to different addressees with known addresses. The recipients of the card have the possibility of approaching the company by returning the reply card that is an integrated part of the echocard.

This method provides an ideal cost-benefit ratio and the company can approach four potential donors per flyer with one positive contact while generating donations even with the first contact. The inclusion of the selection process that is carried out by the card buyer by sending the card to certain addressees is also contemplated.

In this method, the echocard is of utter importance since it is the only communication and interactive medium in the low-cost range which represents such a multi-step process. Using the echocard, the company does not have to conceive and implement a new communication medium—e.g. by gluing together postcards/reply cards which may be subsequently sent off but are relatively ineffective marketing means—but relies on a medium that presupposes such an object to be capable of fully developing its mechanisms.

In this example, the echocard consists of three essential components:

1. a postcard

2. a reply card

3. an integrated data carrier (CD-ROM, DVD-ROM, etc.).

1. The Postcard

The front and picture side corresponds to a motif card having postcard size. The echocard may display all types of motifs, texts, illustrations and graphics and is thus a conventional, known and generally accepted picture/text communication medium.

2. The Reply Card

On the reverse side of the echocard a reply card is integrated (without any seams) that may be removed from the echocard easily and without any damage on account of a perforation. Additional information may be offered or requested on it. A decisive advantage of this integration is that the recipient of the card does not have to solve any problems—in particular buying a reply card.

The employment of a reply card can be decisive for the success of a mailing campaign and optimises the reply rate. This is because at the moment a recipient of a card decides to send a reply, he/she hardly ever has a postcard at hand. Since this is indeed a considerable problem, e.g., magazines use to glue reply cards to the respective pages. The echocard solves this problem itself because the postcard is part of the echocard and is at hand.

The echocard likewise optimises the recipient's convenience and thus the reply rate since the contact data are already on the card.

3. Data Carrier

A data carrier, such as a CD-ROM or a DVD-ROM, etc., is integrated in the echocard. Depending on the data carrier, it offers a storage capacity of up to 1 GB. Films, videos, music, websites, programs, games, forms, documents, books—everything that is or can be digitized that can be stored and presented here.

The data carrier is also printed and thus offers a “third side” for analog communication—an effect that should not be underestimated. Here, the echocard opens up further possibilities since it reaches the electronic equipment in the recipient's personal area, such as PC, computer, stereo equipment, DVD player etc., which are important to him/her. It is therefore an additional printed side for analog communication via the eye/a picture and furthermore a communication means that may be heard, seen (animated pictures) and handled and researched/used.

Combining Communication Channels

The echocard ingeniously combines optimally presented, homogeneous and consistent analog communication while adding and integrating many alternative channels with the integrated CD/DVD. The echocard combines and focuses all channels and avoids deferred contacts. Deferred contacts entail a dilemma: an individual impulse does not suffice to provoke an action, in combination, however, the impulse would be high enough.

Moreover, all target groups may be reached with one single medium in the same way (which is important for recognition). The resources used multiply (they are not simply added, which would entail great losses on account of intersections, as can be the case with efforts to assign different media to different channels). Conventional and known marketing means or products fail on account of this problem. In particular the so-called “new media” failed for ignoring and simply trying to overcome the usual, known communication channels.

Increase in Value

The form of the echocard as a whole as it is perceived by the recipient is likewise important. By the integration of a data carrier, its value is essentially increased for the viewer/recipient. The echocard is completely different to the touch, the recipient is not accustomed to such a thing, he/she encounters something new, unexpected. Therefore, with the respective design, the echocard cannot be understood and classified as a crude advertising/marketing means since it has a core, obviously costs more than a postcard, offers more and thus leaves behind all other cards/postcards. To receive an echocard does not mean to be troubled by an advertising message but rather constitutes an enrichment since it has a value (minimum is its purchase price).

Control and Anticipation

The benefit of the fact that designers and suppliers of the echocard know already how communication between sender and addressee functions/will function. The designers and suppliers prepare the communication and can thus guarantee that it is resistant to mistakes, is optimally prepared and reaches the addressee in the form as intended.

Moreover, the minimum information level the cards create among all recipients and can be known, and the designers and suppliers can prepare themselves for the resulting questions and comments—which is an advantage that should not be underestimated. The knowledge about the smallest common denominator can be used to prepare follow-up campaigns.

The CD/DVD can be of inestimable use in this context since it is capable of offering value in addition to that which has been already supplied, and the interested person already has at hand. There is no time loss, but excellent service, a high information level for those that are really interested. For example, the question “I've lost the transfer form, can you provide me with another?” can be answered by “Just print it out yourself!” The question “I don't have the flyer anymore, where can I get the books?” can be answered by “Order them online, the website is on your CD.” If the recipient cannot even call the company because he/she has lost the flyer, then the website comprising all data is on the CD, etc. The echocard offers a solution where conventional, exchangeable means and products fail.

Flyer Campaign—Basic Prerequisites

Some points are of crucial importance for generating with the echocard a maximum response and thus maximum donation yields combined with the highest possible rate of returned reply cards. The key to success for a flyer campaign includes the following chain, not broken if possible:

1. Generating attention with the flyer campaign (addressee 1)→

2. Understanding the purpose (A 1)→3. Generating a necessity to act (A 1)→

4. Calling the call center and ordering (A 1)→

Partial Aim I is Achieved.

5. Sending postcard (A 1)→

6. Perceiving postcard (A 2)→

7. Recognizing the need to act (A 2)→

8. Sending off reply card (A 2)

Partial Aim II is Achieved.

It should be noted that on account of its multi-step concept, the echocard offers as one of the few logistics and communication means the basic conditions to accompany such a process without a change of the communication and replacement medium. This is a complicated process that per se comprises many points at which the chain can easily break according to experience. The process requires explanation. Each partial step has to offer the person taking action an additional value merely for each partial step per se, i.e. the advantage has to be easily recognizable and understandable for the person taking action in each partial step.

Reaching the Target Groups—Target Groups—Target Groups Subjects for Particular Campaigns

There is difficulty in approaching different demographic target groups—segmentation is probably only sensible with such a mass campaign—since no flyer campaign of this dimension can consider sub-segments, such as profession, education, etc. but has to cope with a so-called “watchfulness” (a wait-and-see attitude in principle until the right incentive is given that provokes an action of the person who is “anyhow waiting”) in different groups of the population.

Therefore, in order to make the total circulation of 64,000,000 a success, so-called subjects of consent are needed for the offer of the flyer campaign which are self-explanatory, which do not depend on a specific demographic group and which are recognized and classified by each target group in the same way as being interesting and having a potential additional value—even if each subject of consent is interpreted and put into action on a different level.

On the basis of the experience of the past years and decades these subjects are:

1. money

2. cars

3. leisure time, holidays and travelling

4. sports

5. to a certain extent shopping/consumption

Prize Draw

The concept and implementation of a prize draw with a double component on the basis of the echocard can be used to generate interest on the part of recipients. This should not be confused with a lottery. This can be particularly useful when the echocard is used to solicit charitable donations; the process chain of repeated pleas is drastically turned into a chain of wishes. Not taking the next step after ordering the card means doing harm to oneself.

The prize draw has several steps. Prizes are drawn quarterly. A monthly draw is desirable, but presumably unrealistic since the time period involved is short. If prizes are drawn quarterly, there should be one main prize from each main prize segment, e.g., travelling—cars—sports.

It should be discussed whether a particularly valuable prize should either be promised quarterly or as a special prize to the group of card purchasers. Thus, the incentive to buy and act is further increased and donors and helpers, who are the actual initiators and vehicles, are being “rewarded”. Moreover, the card recipients are thus more likely to be encouraged to act and pass on good luck and the chance to win.

In correspondence to the order and action procedure, this process is basically as follows:

1. Generating attention with the flyer campaign (addressee 1)

[symbol]

The flyer refers to a prize draw. Winning is self-explanatory in any target group. The subject “helping and winning” can be conveyed, which means an image transfer for the further contact with the soliciting company. Whoever sends out a card can win him/herself and give other persons whom he/she provides with a card thus a chance to win. He/she in fact secures a chance to win, which per se has an optimum cost/benefit ratio in view of the money spent, and moreover the status of a benefactor vis-à-vis third persons—without any costs. Those who are particularly smart return the reply card with their own data and thus gain a double chance to win.

2. Understanding the purpose (A 1)

See above. Only those who give the call center a call can participate. Thus, the fear of calling a call center is reduced. Winning is the primary impulse and not the following idea: “I have to call someone who wants something from me but does not even answer the phone in person.” The respective telephone charges are moreover relatively low. Those who want to win do not care about the anonymity of a call center whereas those who want to get information from the company and call the call center, do not have high expectations and are not disappointed.

3. Generating a necessity to act (A 1)

[symbol]

This is self-evident with a prize draw and is understood by any potential participant. The benefit here is that the number of potential addressees is increased dramatically. Persons who would call the company even without any prize draw since they are interested, are not excluded. A double positive situation is created and not an exclusive-or situation.

4. Calling at the call center and ordering (A 1)

[symbol]

The fact that “attention—interest—decision” and “action” in the AIDA model do not happen at the same time is a problem that should not be underestimated. Research in this context has shown that action is never taken immediately if the addressee has a flyer at hand. This holds in particular true if someone has to do something to help others without any advantage for him/herself. Similar messages frequently overlay the initial desire to act. Not calling means—for addressees who like gambling and winning—having the sudden feeling to have missed something and to have harmed oneself.

Partial aim (I) is reached

5. Sending the postcard (A 1)

[symbol]

This is also simplified with a prize draw and probably more action is provoked by the echocard as compared with conventional postcards. The difference may be because the chance to win is likely to be given away as quickly as possible so as to show the addressees 2 that the sender thinks of them and really wishes them the best. Otherwise, many people would probably keep the cards because of their increased value (CD/DVD) and use them for special events, which would make the content of the CD/DVD less current.

6. Perceiving the postcard (A 2)

[symbol]

7. Recognizing the necessity to act (A 2)

[symbol]

8. Sending off reply card (A 2)

[symbol]

For these items, the benefit of a prize draw is likewise self-evident. Even if someone orders the cards and sends them off, there will be a massive loss in the A 2 group. A high reply rate would imply that the sender has carefully reflected whom he/she should provide with a card so that this person will take action and will not only recognize the necessity to return the reply card but actually return it, which, in turn, would presuppose that both in this process chain recognize the necessity to support the charity. This leads to almost insurmountable barriers between the demographic target groups—even when not considering those who are anyhow interested in this subject.

This situation is completely reversed by the prize draw—not returning the card means no prize—without any expenditure of cost or time being involved. Moreover, the sender is probably interested in finding out whether the recipient has taken action.

Partial aim II is reached with an increased reply rate.

The available resources are used as follows:

1. Flyer—advertising space

Since numerous sponsors are needed in order to make the prize pool as big as possible, and there are almost no cash prizes but merely things to win (which distinguishes a prize draw from a lottery), a specific logo/Cl should be developed and used for the prize draw reflecting the company. This logo/Cl should be combined with a representation of the three categories cars—travelling—sports from which the reader of the flyer can conclude the prize category. The three motifs should later appear on the card and should dominate its appearance (variant 1).

2. CD/DVD content

The CD/DVD space may be used for content which is provided by the sponsors. This probably also increases the value for A 2 and will be achieved more easily by optimising the cost-benefit ratio in co-operation with the owners of the rights. The hits of the sponsors' commercial spots, e.g., travel videos, motor sport simulations, offline versions of Internet appearances or gratuitous Internet access trials, etc., could be packed into this CD. Anyway, with the sponsors' help the content will be by far more precious than without their help.

3. Echocard—appearance—layout

The Echocard appearance and layout will depend on the sponsor. Since the cards are offered in, for example, packs of three, it is, however, a nice variant to select a main motif for each of the main categories travelling—cars—sports.

This could also be applied to the prize draw, e.g., by the selection of three precious main prizes. Those returning the card illustrating the travel subject (e.g. trip to palm beach) stand a chance to win the main/special prize in the travel-category etc.

However, the respective card should in any case create the transfer “I (A 1) am thinking of you (A 2) and wish something good to you”. Should this idea be adopted, respective prize proposals can be made.

Moreover, the card should be designed such that the card recipient will afterwards be capable of understanding and reconstructing this process. Thus, he/she is encouraged to take action as the initiator of a line of fortune/prize chain. In this concept, the card is not the end of the process chain but an independent advertising means opening up new cycles. The initial obstacle of having to take action is less since the addressee has already gained a prize, i.e. he/she has received a positive service for free.

In addition to the above items, the following steps may be taken:

1. First of all, existing sponsors should be asked whether they would also like to be sponsors for the prize draw.

2. Packs for individual sponsors and bulk purchasers which put them in the focus of the card design can be provided. They could then send out cards to their customers, employees and partners. The classic win-win situation is as follows: major customers get the possibility of taking advantage of the benefits of a prize draw which they could not devise and implement on their own whereas many cards can be sold at once and reach a specific target group which can clearly be identified by the company. Moreover, the company can profit from known names. In this context, special prize draws for specific major customers are also possible.

3. Media co-operation constitutes an interesting add-on, particularly in view of item 2. The publishers receive a marketing tool (echocard—prize draw) for their main titles or for soliciting subscribers which they could not finance on their own. Particularly the advertisement and editorial spaces that can be gained is of special interest. With the media co-operation, it is able to position and convey the subject in magazines, journals, newspapers and the like so that it has a lasting effect. All sponsors are mentioned and positioned in the part introducing the prize draw since the media are interested in giving an impression of the size and attractiveness of the prize draw. A major media partner can, e.g., publish the winner lists, which directs further attention to the whole campaign.

4. The prize draw can be given an outstanding position on the website of the company. A subsite should be built up.

5. The prize draw may be continuously attended to in the press and media taking into account the respective target groups (i.e. end consumer—bulk purchasers—sponsors).

6. A marketing package may be devised for the sponsors, which makes it more easy and efficient for them to profit from their commitment. Thus, attention is increased one is able to utilize the sponsors' communication contacts more efficiently. In such a package, the focus is on the sponsor.

### EXAMPLE II

### Short Description of a Flyer Campaign Concept of the Echocard Campaign

Due to its multi-step structure, the echocard is the only suitable means to multiply several steps and include and use the purchasers as selective distributors.

Concept

A high-volume prize draw represents for the flyer contacts a decisive additional value/buying impulse inducing them to buy an echocard offered in the course of a flyer campaign. A prize pool of [symbol] 250.000,—and more is necessary and moreover realistic. The prize pool comprises no cash prizes but merely things to win. The prize pool has to be completed four months before each draw. (The first draw is an exception.)

There should be four prize draws a year, if possible at the beginning of each season (spring, summer, autumn and winter) since the seasonal motifs per card pack change. Should many small prizes be donated, monthly draws in between could by arranged.

The winners are drawn in co-operation with a major national media partner, such as a major TV magazine.

Two echocard packs are offered:

Pack 1: Three cards with three different motifs.

Pack 2: Three cards displaying the same motif.

Since the prize draw results in a considerable image transfer/increase and follow-up contacts not only for the company but in particular for the sponsors of the prize draw, the company should be the first to decide on a participation in a prize draw in which the echocard is in the center of attention in addition to their commitment so far.

Structure and concept of the cards

The echocard has four sides that have to be designed.

| | |
|---|---|
| 1 | main card, front |
| 2 | integrated card, back = main card, outward reverse side |
| | (visible, if closed) |
| 3 | main card inward reverse side (invisible, if closed) |
| 4 | integrated card, back |
| 4 | integrated card, front (invisible, if closed) |
| 5 | integrated CD-ROM |

1 Front of the Main Card

The motifs cover the front completely and show events/goods of a high status, such as distant destinations, expensive cars, precious consumables, sports/sport events, shares/funds/money, in short: things that attract people of all ranks and consumption patterns and arouse positive associations. This motif is labelled depending on the occasion, e.g. “Happy birthday and many happy returns,” “Get well again soon and our best wishes,” “Merry Christmas and our best wishes,” “Have a nice holiday. Best wishes,” “Joy shared is joy doubled,” “I am thinking of you,” etc.

A hint at the integrated CD-ROM with many add-ons, extras, music, videos etc. completes the front design. The company is not mentioned on the front.

The card buyer thus does not send out a card that is a simple advertisement for the company; buying the motifs per se makes sense. The buyer combines four essential things when sending out the cards:

1. He/she thinks of someone, his/her sending or giving away the card proves this.

2. He/she has already done something good in the name of someone else. A corresponding note is provided on the back: “Purchasing this card means supporting [the company]”.

3. He/she does someone a favor since this person gets a chance to win without having to pay for it him/herself. He/she simply has to return the reply card.

4. The buyer participates in the prize draw, he/she can benefit from his/her noble deed him/herself.

2 Integrated card, back=main card, outer reverse side (visisble, if closed)

Left Column

space for sender's particulars

reference to the donation already made

reference to the chance to win

if any, reference to foundation and sponsors

Right Column

address field according to postal service standards

stamping/franking space

3 Main card, inner reverse side

1. address field, sender field, reply card, participant in the prize draw

2. address of the company

3. check-off box for participation in the prize draw

4. check-off box for requesting

further information about the company

further information about the main sponsors' products promoted by the campaign

the echocard

4. Integrated Card, Front

Design corresponds to the flyer layout (so far no final version)

call center number

prize draw logo

combined mark of the company

further information on the company

further information on the main sponsors' products promoted by the campaign

echocard ordering

“Good luck! The partners of [the company]”+logos of the main sponsors of the prize draw

picture and message of the company

5 Integrated CD-ROM

On the CD, in the DVD-CD portion are: videos/film sequences, commercial spots, pieces of music, VIP statements etc.

In the data portion, the following is available via a browser: games, documents, introduction to the company, order forms, information, links to sponsors and all partners, etc.

The sponsors of the prize draw can use the entire storage capacity. The CD-ROM is primarily intended for entertainment and fun and only secondarily for conveying the preoccupation of the company and promoting its partners' products.

Prize Draw Process

1. The echocard prize draw is announced on the flyers (⅓ of a page).

2. Those interested call at the call center and order a pack or they order it via e-mail. The payment mode has not yet been defined, payment by credit card, automatic debit transfer/direct debiting, SMS (in particular vodafone m-pay, slimcash, etc.), perhaps transfer or check are conceivable.

3. The pack provided comprises a. 3 motif cards, b. the flyer.

4. By ordering, the buyer automatically participates in the prize draw.

5. The buyer sends out the cards to friends, acquaintances etc.

6. The occasion-related or seasonal texts define the respective occasions.

7. The recipient separates the integrated card from the postcard and returns the main card with his/her personal data and further information to the company. The person receiving the integrated card also keeps the CD-ROM.

Benefits—Advantages

For the card buyer:

He/she does not only support the company in an unselfish manner, but also gets a chance to win him/herself.

He/she gives other people a chance to win. The card concept makes the card interesting to companies as well since for being a combination of congratulatory and prize-draw card, the echocard possesses a distinctiveness which would otherwise not be possible.

Other people get to know the sender's noble deed.

The sender does not send out a simple advertising card with a message but a card that is worth its price if only because of its superior appearance (design, motif, weight, contents (CD-ROM)). This card stands out against other greeting card because of its message “Not only do I wish you luck but I have already done something for your luck by buying this card.”

For the sponsors:

The card once again transports the sponsors' message.

The buyer sends out the card using his/her private address list and serves as multiplier.

The database is multiplied. The data of the card recipients are made available in addition to the buyer's data should they participate in the prize draw.

Later on, it is possibly far easier to get into contact with the participants in the prize draw since a positive contact has already been made and the recipient in a way “owes us something” because he/she intended to win without giving us something in return.

Thus, the cross selling efforts of the partners reach persons who would otherwise not be appealed and would not be interested.

The sponsors profit from the selection of the sender who thus indirectly delivers the message of the sponsors and the company and testifies to their good reputation.

The CD-ROM offers further information space (such as order forms) which the flyer or the call center can by no means provide.

The card is a material message of unlimited access time whereas contacting the call center is a virtual experience that is limited; you feel more informed, your inhibitions are lessened.

While the invention has been described in connection with specific embodiments thereof, it will be understood that it is capable of further modifications and this application is intended to cover any variations, uses, or adaptations of the invention following, in general, the principles of the invention and including such departure from the present disclosure as come within known or customary practice within the art to which the invention pertains and as may be applied to the essential features hereinbefore set forth and as follows in the scope of the appended claims.

What is claimed is:

1. A postcard, comprising:
one or more peripheral sides capable of being folded onto a first side and joined, forming a receiving space for a data carrier, wherein the data carrier being a predetermined size that fits within said receiving space and wherein the one or more peripheral sides are sealed so that the one or more peripheral sides cannot be opened unintentionally and the data carrier cannot be lost.

2. The postcard according to claim 1, further comprising a slot in at least one of the one or more peripheral sides, wherein said slot is capable of receiving a portion of a second peripheral side.

3. The postcard according to claim 2, further comprising a tab on at least one of the one or more peripheral sides, wherein said tab can be received by said slot.

4. The postcard according to claim 1, further comprising an adhesive portion on at least one of the one or more peripheral sides.

5. The postcard according to claim 1, further comprising an adhesive label adhered to said at least one or more peripheral sides.

6. The postcard according to claim 1, wherein at least one of the one or more peripheral sides is separable by one or more perforations.

7. The postcard according to claim 1, wherein the data carrier is selected from the group consisting of a credit card, a computer disk, a compact disk, a CD-ROM, a DVD, a mini CD, a trimmed CD, a CD of a thin film material, and a video disk.

8. The postcard according to claim 1, further comprising a means for fixing the data carrier to the postcard.

9. The postcard according to claim 1, further comprising an Advent calendar or a greeting card.

10. The postcard according to claim 1, wherein at least one of the peripheral sides comprises a permission ticket.

11. The postcard according to claim 1, wherein at least one of the one or more peripheral sides can be reused as a postcard.

12. The postcard according to claim 1, wherein the postcard comprises at least two peripheral sides, and wherein at least one of the two peripheral sides is adapted to be written on.

13. The postcard according to claim 1, wherein the data carrier is accessible by removing fully or partially at least one of the peripheral sides.

14. The postcard according to claim 1, wherein the postcard comprises at least two peripheral sides, and wherein said at least two peripheral sides include a separable adhesive joint.

15. The postcard according to claim 1, wherein two peripheral sides are foldably connected to the first side, and wherein the receiving space for the data carrier is formed by the two peripheral sides folded onto the first side, and wherein at least one of two peripheral sides is separable, and wherein the first side comprises a postcard.

16. The postcard according to claim 1, wherein the at least one peripheral side is attached to the first side by an adhesive joint.

17. The postcard according to claim 1, wherein the at least one peripheral side comprises doors capable of being opened by perforation means.

18. The postcard according to claim 1, wherein the data carrier is fixed to the postcard by a recess, a raised element, or an adhesive spot.

19. A method of generating a customer database, comprising:
mailing or delivering a postcard or information carrier to an addressee, wherein said postcard includes a reply postcard that requires information to be furnished by the addressee, and wherein said data carrier includes information of interest to the addressee;
receiving said reply postcard from the addressee, and converting said information into computer-readable format to generate a customer database based on the information furnished by the addressee; and
using said customer database to generate a mailing list to solicit or send further information or products to the addressee.

20. The method according to claim 19, wherein the postcard or information carrier further comprises an admission ticket, a contest entry, or a calendar.

21. An information carrier, comprising:
one or more peripheral sides capable of being folded onto a first side and joined, forming a receiving space for a data carrier, wherein the data carrier being a predetermined size that fits within said receiving space and wherein the one or more peripheral sides are sealed so that the one or more peripheral sides cannot be opened unintentionally and the data carrier cannot be lost.
